(19) United States
(12) Patent Application Publication
(10) Pub. No.: US 2024/0021401 A1
(43) Pub. Date: Jan. 18, 2024

(54) X-RAY TUBE

(71) Applicant: CANON ELECTRON TUBES & DEVICES CO., LTD., Otawara-shi (JP)

(72) Inventors: Tomonobu SAITO, Yaita (JP); Takashi SHIMONO, Nasushiobara (JP)

(73) Assignee: CANON ELECTRON TUBES & DEVICES CO., LTD., Otawara-shi (JP)

(21) Appl. No.: 18/446,616

(22) Filed: Aug. 9, 2023

Related U.S. Application Data
(63) Continuation of application No. PCT/JP2021/026831, filed on Jul. 16, 2021.

(30) Foreign Application Priority Data
Feb. 12, 2021 (JP) 2021-020784

(51) Int. Cl. H01J 35/18; H01J 35/16

(52) U.S. Cl. CPC H01J 35/18; H01J 35/165

(57) ABSTRACT

According to one embodiment, an X-ray tube includes a vacuum enclosure that maintains a vacuum inside, a cathode provided in the vacuum enclosure, which emits an electron beam, an anode target provided in the vacuum enclosure, which emits an X-ray when the electron beam emitted from the cathode enters a focal plane of the anode target, and an X-ray radiation window that allows the X-ray emitted from the focal plane of the anode target to pass therethrough, and the X-ray radiation window comprises a window member and a support for the window member, the vacuum enclosure includes a joint portion formed thereon to be joined to the support and protrude toward an outer side of the vacuum enclosure, and the support comprises a covering portion that covers an inner circumferential surface of the joint portion.

### CROSS-REFERENCE TO RELATED APPLICATIONS

This application is a Continuation Application of PCT Application No. PCT/JP2021/026831, filed Jul. 16, 2021 and based upon and claiming the benefit of priority from Japanese Patent Application No. 2021-020784, filed Feb. 12, 2021, the entire contents of all of which are incorporated herein by reference.

### FIELD

Embodiments described herein relate generally to an X-ray tube.

### BACKGROUND

Generally, X-ray tubes comprise a vacuum enclosure that holds a vacuum inside, a cathode provided inside the vacuum enclosure, which emits an electron beam, an anode target provided inside the vacuum enclosure, which emits an X-ray when the electron beam emitted from the cathode enters a focal plane, and an X-ray radiation window that allows X-rays emitted from the focal plane of the anode target to pass through.

In such an X-ray tube, it is known that recoil electrons are generated when the electron beam emitted from the cathode strikes the focal plane of the anode target. The recoil electrons fly out in all directions, and the electric field make them to fly toward in the direction of low potential. Some recoil electrons emit secondary electrons when they strike the vacuum envelope.

These recoil electrons and secondary electrons cause a charging phenomenon on an inner surface of the vacuum envelope, which increases the potential gradient between the vacuum envelope and the X-ray radiation window and facilitates the generation of electrical discharges. Thus, such defects may occur that abnormal X-ray images of X-rays are created obtained through the X-ray radiation window, equipment is shutdown, and the like.

With regard to such defects, a technology has been proposed to prevent recoil electrons and secondary electrons from heading toward the inner surface of the vacuum enclosure by providing a hood or the like, that covers the anode target.

However, the conventional technique of preventing recoil electrons and secondary electrons from heading toward the inner surface of the vacuum enclosure involves such a drawback that the equipment is complicated.

The present embodiment has been proposed in consideration of the above-provided points, and an object thereof is to provide an X-ray tube having a simple configuration that can prevent defects such as abnormal X-ray images and equipment shutdown.

### BRIEF DESCRIPTION OF THE DRAWINGS

FIG. 1 is a vertical cross-sectional view schematically showing a configuration of an X-ray tube according to the embodiment.

FIG. 2 is a vertical cross-sectional view schematically showing a configuration of an X-ray tube according to a comparative example.

### DETAILED DESCRIPTION

In general, according to one embodiment, An X-ray tube comprising: a vacuum enclosure that maintains a vacuum inside; a cathode provided in the vacuum enclosure, which emits an electron beam, an anode target provided in the vacuum enclosure, which emits an X-ray when the electron beam emitted from the cathode enters a focal plane of the anode target, and an X-ray radiation window that allows the X-ray emitted from the focal plane of the anode target to pass
therethrough, wherein
the X-ray radiation window comprises a window member and a support for the window member,
the vacuum enclosure includes a joint portion formed thereon to be joined to the support and protrude toward an outer side of the vacuum enclosure,
the support comprises a covering portion that covers an inner circumferential surface of the joint portion, and
the covering portion is a cylindrical portion extending to an inner side of the vacuum enclosure along a radiation direction of the X-ray and is formed to be integrated with the support as one body.

An X-ray tube of an embodiment will be described in detail with reference to the accompanying drawings. Note that in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

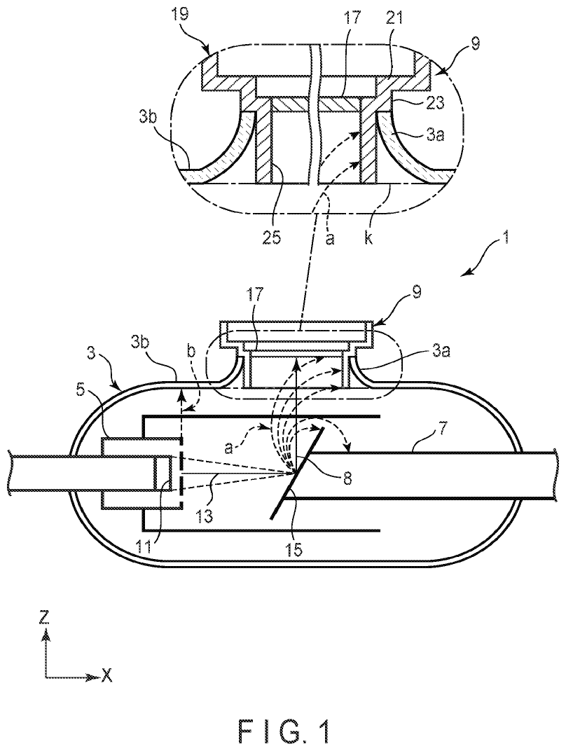

As shown in FIG. 1, an X-ray tube 1 is a fixed-anode X-ray tube and comprises a vacuum enclosure 3 that maintains a vacuum inside, a cathode 5 provided inside the vacuum enclosure 3, an anode 7, and an X-ray radiation window 9.

The vacuum enclosure 3 is formed from an insulating material such as glass or ceramics.

The cathode 5 is disposed on one side in the vacuum enclosure 3 and is provided with a filament 11. The cathode 5 emits an electron beam 13 from the filament 11 toward an X direction in FIG. 1.

The anode 7 is disposed on the other side in the vacuum enclosure 3 so as to oppose the cathode 5, and is provided with an anode target 15. The anode target 15 emits X-rays 8 toward a Z direction in FIG. 1 when the electron beam 13 emitted from the filament 11 of the cathode 5 strikes the focal plane.

The X-ray radiation window 9 is constituted by a window member 17 and a support 19 that supports the window member 17.

The window member 17 is formed of a material with which the attenuation of an X-ray 8 is low, that is, for example beryllium (Be), and is thinly formed to have a thickness of several tens of μm to several hundreds of μm. The window member 17 allows the X-ray 8 to pass therethrough while maintaining an airtight state inside the vacuum enclosure 3.

The support 19 is insulated from the anode 7 and the cathode 5 and is designed to be capable of sufficiently withstanding to high voltages.

The support 19 comprises a window member holding portion 21, a support-side joint portion 23 which is joined to an enclosure-side joint portion (joint portion) 3a formed in the vacuum enclosure 3, and a covering portion 25.

The enclosure-side joint portion 3a is formed continuously from an enclosure body 3b to protrude toward an outer side of the vacuum enclosure 3.

The covering portion 25 is formed into a cylindrical shape and is disposed on an inner circumferential side of the enclosure-side joint portion 3a with respect from the support-side joint portion 23 and is provided along an inner circumferential surface of the enclosure-side joint portion 3a, so as to cover the entire inner circumferential surface of the enclosure-side joint portion 3a.

Further, in the present embodiment, the covering portion 25 is disposed on an inner side of the vacuum enclosure 3, with respect to the window member holding portion 21, where the window member 17 is attached, and it extends to a rise up start position K of the enclosure-side joint portion 3a.

Next, the operational effects of this embodiment will be described.

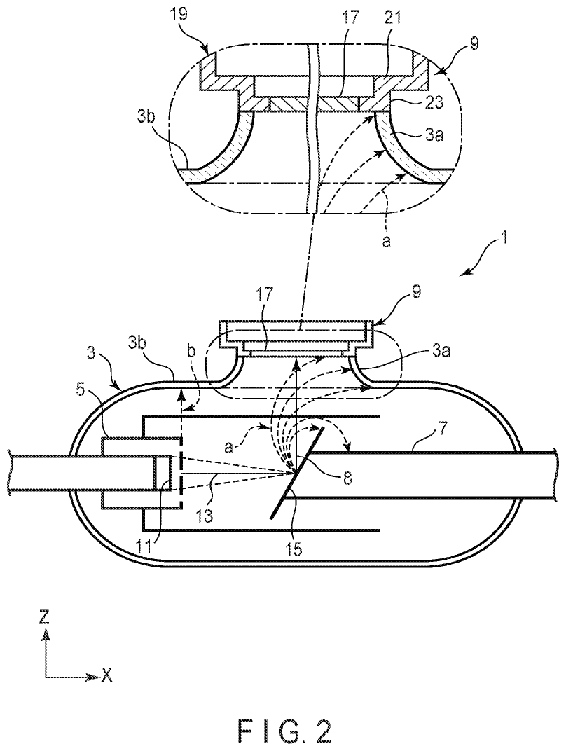

First, with reference to FIG. 2, which shows a comparative example, the case without the covering portion 25 will be explained. Note that in FIG. 2, parts that exhibits the same effects as those of the X-ray tube 1 of the above-described embodiment are denoted by the same reference symbols. The comparative example is different from the embodiment only in that the covering portion is not formed on the support 19.

The electron beam 13 emitted from the filament 11 of the cathode 5 generates recoil electrons a when it hits the anode target 15 of the anode 7. The recoil electrons a fly out from the anode target 15 in all directions and fly in a direction of low potential due to the electric field. When some of the flying out recoil electrons a collide with the inner surface of the vacuum enclosure 3, the vacuum enclosure 3 is charged positively or negatively by the secondary electron emission coefficient. Further, electrons b emitted from the cathode 5 collide with the vacuum enclosure 3 in the same manner, and the vacuum enclosure 3 is charged positively or negatively. Note here that the direction of the recoil electrons a and the field-emitted electrons b varies depending on the design of the X-ray tube 1 and the electric field. Further, secondary electrons are produced when the recoil electrons a collide with the vacuum envelope 3.

Then, when the recoil electrons a flying toward the X-ray radiation window 9 collide with the enclosure-side joint portion 3a of the vacuum enclosure 3, an electric potential difference is generated due to charging, and a discharge occurs in this area, which may cause an adverse effect on the X-ray 8 that passes through the X-ray radiation window 9.

By contrast, as shown in FIG. 1, in the X-ray radiation window 9 of this embodiment, the covering portion 25 of the support 19 covers the inner circumferential surface of the outer enclosure-side joint portion 3a of the vacuum enclosure 3, and this it is possible to prevent the recoil electrons a flying toward the X-ray radiation window 9 from colliding with the enclosure-side joint portion 3a of the vacuum enclosure 3. In this manner, this part is prevented from being positively or negatively charged in the enclosure-side joint portion 3a.

As described above, when the X-ray tube 1 is in use, the charging phenomenon is prevented around the X-ray radiation window 9, the potential gradient between the vacuum enclosure 3 and the support 19 of the X-ray radiation window 9 is reduced, thereby making it possible to make electrical discharges less likely to occur around the X-ray radiation window 9. Thus, defects such as abnormal X-ray images and equipment shutdown can be prevented.

Further, in this embodiment, it is merely that a covering portion 25 that covers the inner circumferential surface of the outer enclosure-side joint portion 3a is formed on the support 19 of the X-ray radiation window 9, and therefore the configuration is simple.

Furthermore, in this embodiment, the covering portion 25 is located on an inner side of the vacuum enclosure 3 as compared to the position where the window member 17 is attached. With this configuration, defects caused on the X-ray 8 passing through the window member 17 due to charging of the outer enclosure-side joint portion 3a can be effectively prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the covering portion 25 is formed to be integrated with the support 19 as one body, but may be made separately and fixed to the window member holding portion 21.

Further, the shape of the covering portion 25 is not limited to a cylindrical, but may also be a conical cylinder whose diameter narrows down toward the inner side of the vacuum enclosure 3.

What is claimed is:

1. An X-ray tube comprising: a vacuum enclosure that maintains a vacuum inside; a cathode provided in the vacuum enclosure, which emits an electron beam, an anode target provided in the vacuum enclosure, which emits an X-ray when the electron beam emitted from the cathode enters a focal plane of the anode target, and an X-ray radiation window that allows the X-ray emitted from the focal plane of the anode target to pass therethrough, wherein
the X-ray radiation window comprises a window member and a support for the window member,
the vacuum enclosure includes a joint portion formed thereon to be joined to the support and protrude toward an outer side of the vacuum enclosure,
the support comprises a covering portion that covers an inner circumferential surface of the joint portion, and
the covering portion is a cylindrical portion extending to an inner side of the vacuum enclosure along a radiation direction of the X-ray and is formed to be integrated with the support as one body.

2. The X-ray tube of claim 1, wherein
the covering portion is disposed on an inner side of the vacuum enclosure as compared to a location where the window member is attached.
